(19) United States
(12) Patent Application Publication
(10) Pub. No.: US 2013/0268342 A1
(43) Pub. Date: Oct. 10, 2013

(54) SYSTEMS AND METHODS FOR A REDEEMABLE POINTS CLEARINGHOUSE

(71) Applicants: James J. Tune, Gilbert, AZ (US); John M. Rojewski, Glendale, AZ (US)

(72) Inventors: James J. Tune, Gilbert, AZ (US); John M. Rojewski, Glendale, AZ (US)

(73) Assignee: American Express Travel Related Services Company, Inc., New York, NY (US)

(21) Appl. No.: 13/439,106

(22) Filed: Apr. 4, 2012

(51) Int. Cl. G06Q 30/02

(52) U.S. Cl. 705/14.29

(57) ABSTRACT

A host clearinghouse account manager may maintain a system, such as a middleware system, for converting and/or exchanging loyalty points to value credits. The host clearinghouse's system middleware determines the appropriate number of loyalty points from a first merchant's loyalty point system to convert and/or exchange by implementing a conversion processor that converts the participant's loyalty points to an appropriate value credit equivalent. These value credits may then be converted and/or exchanged to loyalty points in a second merchant's loyalty point system.

### FIELD OF DISCLOSURE

The present disclosure generally relates to the exchange of loyalty points for items and more particularly, to systems and methods for establishing a standard exchange for loyalty program benefits.

### BACKGROUND OF DISCLOSURE

Incentive traditional loyalty (e.g., incentive award, frequency reward, etc.) programs have been around for years. Loyalty programs are typically used to help businesses develop and maintain participant loyalty and are used as marketing tools to develop new clientele. A frequent flyer program is an example of a typical loyalty program, where the more the participant uses a particular airline or group of affiliated airlines the more frequent flyer miles the participant earns. After accumulating frequent flyer miles, the participant may choose to redeem those miles for upgrades in service or free airline tickets. Various forms of these programs have developed over the years, ranging from programs such as “buy 9 get one 1” punch cards to more sophisticated credit card loyalty systems, where participants are awarded points for using a particular transaction card and/or by using a transaction card with particular merchants or vendors. As competition in various markets increased, companies sought ways to expand loyalty programs to appeal to a broader cross-section of potential customers. One way this was accomplished was by developing strategic partnerships and affiliations with other business sectors. For example, hotel chains, airlines and rental car agencies developed loyalty program partnerships and affiliations; credit and transaction card companies also joined in to promote a more comprehensive and appealing loyalty program. These programs have been successful, but again were limited in that the loyalty points could only be redeemed within the network of companies in the loyalty program affiliation or partnership.

Although many of these programs have been successful in developing customer loyalty and incentivizing customers to act, they have presented participants with limited opportunities to redeem loyalty points for the products of their choice or have provided participants with limited accessibility and control of their loyalty account. Therefore, a need exists in this industry for a program that expands product choice for loyalty program participants.

### SUMMARY OF THE DISCLOSURE

These above needs are successfully met via the disclosed system and method. For instance, the present system and method improves the acquisition power of any participating loyalty program. In general, the system of the present disclosure overcomes the limitations and problems of the historical programs by providing a system and method for facilitating virtually any loyalty transaction over a computerized network using any type of loyalty program. This system is not limited to merely exchanging loyalty points for product.

In various exemplary embodiments, a participant desiring to redeem loyalty points to facilitate a particular transaction over a computerized network, such as the internet invokes a process to apply an established “value credit” (corresponding to a defined amount of loyalty points) from the participant's designated value credit account. In various embodiments, a first program's set of loyalty points are exchanged first to a standard of value credits and then from the standard of value credits to loyalty points in a second loyalty program. The exchange of loyalty points to and from value credits is generally transparent to the second merchant having the second loyalty program in that the second merchant may be unaware that the customer is initially using a first program's set of loyalty points and/or value credits.

The present disclosure may or may not be integrated into a merchant or shopping network. Historical loyalty programs have been directed towards redeeming points with a point-service system in an online shopping mall established through a network. These systems are limited, however, as these systems are also directed to managing, within a network of participating vendors, the accumulation of points from one vendor (with a particular accumulation ratio) and redemption of points with another vendor (with another redemption ratio). The current system contemplates multiple networks being able to be linked using embodiment of the present disclosure from multiple loyalty points vendors.

In various exemplary embodiments, a system is disclosed including a processor configured to convert loyalty points to a standard value credit, a tangible, non-transitory storage memory configured to communicate with the processor, the tangible, non-transitory storage memory having instructions stored thereon that, in response to execution by the processor, cause the processor to perform operations. The system may comprise granting, by the processor, access to a participant to a user interface in response to a verified log on by the participant and converting, by the processor, a first value of loyalty points in a first loyalty point system to a first value of value credits according to a first conversion ratio, wherein the first conversion ratio is particular to a first merchant. The system may comprise storing by the processor, the first value of value credits. Additionally, the system may comprise converting, by the processor, a second value of value credits to a second value of loyalty points in a second loyalty point system according to a second conversion ratio, wherein the second conversion ratio is particular to a second merchant.

In various exemplary embodiments, the system will further comprise transmitting, by the processor, instructions to the second loyalty point system to adjust the loyalty point balance to the second value of loyalty points. Also, The system may comprise storing, by the processor, data representing a value of value credits associated with an account of the participant. The system may comprise transmitting, by the processor, instructions to a merchant affiliated with the second loyalty point system to perform a redemption of loyalty points.

In various embodiments, the system may comprise converting, by the processor, a third value of value credits to a third value of currency equivalent to be stored to a transaction account. The transaction account may be a pre-paid account. The system may comprise enrolling a participant in the system in at least one participating merchant loyalty system automatically without participant enrollment personal information being provided by the participant to the system. The system provider may provide a guarantee associated with loyalty point exchange transactions. Loyalty point exchange offers may be presented to a participant based on historical transaction account spend trends. Also, a fee may be assessed by the system administrator for each loyalty point exchange.

In various exemplary embodiments, the system may further comprise verifying a loyalty point balance of a participant in a third party loyalty system. The system may comprise establishing with a merchant loyalty point system provider a conversion ratio applicable to loyalty point exchanges by contract. Additionally, the system may comprise further comprising offering suggestions of loyalty points exchanges based on at least one frequency of loyalty point use and frequency of loyalty point accrual. The system may comprise offering suggestions of loyalty points exchanges via a user interface based purchasing power of loyalty points.

In various exemplary embodiments, the system may comprise adjusting the conversion ratio of loyalty point exchange in response to the volume of historical loyalty point exchanges of the participant. The system may comprise presenting an offer of an item to purchase with loyalty points based on a particular participant's loyalty point aggregated purchasing power balance. The system may comprise populating loyalty point system information via a digital wallet. The loyalty point exchange system may be administered by a transaction account issuer. Transactions using this system may be completed using both loyalty points and a transaction account,

### BRIEF DESCRIPTION OF EXEMPLARY DRAWINGS

A more complete understanding of the present disclosure may be derived by referring to the detailed description and claims when considered in connection with the Figures, wherein like reference numbers refer to similar elements throughout the Figures, and:

FIG. 1 illustrates exemplary components of according to various embodiments;

FIG. 2 illustrates an exemplary schematic overview of the architecture according to various embodiments; and

FIG. 3 illustrates an exemplary process flow diagram architecture according to various embodiments.

### DETAILED DESCRIPTION OF EXEMPLARY EMBODIMENTS

The detailed description of various exemplary embodiments herein makes reference to the accompanying drawings and pictures, which show the exemplary embodiment by way of illustration. While these exemplary embodiments are described in sufficient detail to enable those skilled in the art to practice the disclosure, it should be understood that other embodiments may be realized and that logical and mechanical changes may be made without departing from the spirit and scope of the disclosure. Thus, the detailed description herein is presented for purposes of illustration only and not of limitation. For example, the steps recited in any of the method or process descriptions may be executed in any order and are not limited to the order presented. Moreover, any of the functions or steps may be outsourced to or performed by one or more third parties. Furthermore, any reference to singular includes plural embodiments, and any reference to more than one component may include a singular embodiment.

Systems, methods and computer program products are provided. In the detailed description herein, references to “various embodiments”, “various embodiments”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. After reading the description, it will be apparent to one skilled in the relevant art(s) how to implement the disclosure in alternative embodiments,

in various embodiments, the methods described herein are implemented using the various particular machines described herein. The methods described herein may be implemented using the below particular machines, and those hereinafter developed, in any suitable combination, as would be appreciated immediately by one skilled in the art. Further, as is unambiguous from this disclosure, the methods described herein may result in various transformations of certain articles.

In general, the present disclosure uniquely integrates disparate loyalty programs and a host clearinghouse account manager 101 (loyalty points/value credit bank) to more effectively use loyalty points to facilitate transactions. Specifically, the system and methods described herein, allow an individual/participant 10 to convert (and aggregate) loyalty points (such as points awarded to a participant 10 in the American Express Membership Rewards® Program) to a “value credit” 150 (e.g., a value determined according to a standard particular to each individual participating merchant) in order to facilitate a purchase or other transaction. In various embodiments, this system 100 riot only provides a mechanism for converting loyalty points to a value credit 150 to purchase merchandise, but it also comprises integrating with existing account manager settlement systems such as accounts receivable and accounts payable processes to facilitate transaction processing.

A loyalty program participant desiring to spend accumulated loyalty points generally selects products or services for purchase from an individual merchant or a shopping/redemption network of merchants. For example, in an online transaction, the participant may select a “pay with loyalty points” hyperlink button, thereby invoking a process to convert accumulated loyalty points to value credits 150 and the to the instant merchants loyalty point system. in various embodiments, in an online transaction, the participant may select a “pay with loyalty points” hyperlink button, thereby invoking a process to convert accumulated loyalty points to value credits 150 and then use the value credits 150 directly to perform the transaction. In various embodiments, in an online transaction, the participant 10 may convert their loyalty points to value credits 150 and then convert the value credits 150 to a cash/dollar equivalent and use the cash/dollar equivalent to perform a transaction.

In various embodiments, a system may include a processor configured to exchange loyalty points, a tangible, non-transitory storage memory configured to communicate with the processor, the tangible, non-transitory memory having instructions stored thereon that, in response to execution by the processor, cause the processor to exchange loyalty points as described below.

in various embodiments, a host clearinghouse account manager 101 may maintain a system 300, such as a middleware system 200 for converting and/or exchanging loyalty points to value credits 150. During this process, the host clearinghouse's account manager 101 middleware system 200 determines the appropriate number of loyalty points from a first merchant's loyalty point system to convert and/or exchange by implementing a conversion processor that converts the participant's 10 loyalty points to an appropriate value credit 150 equivalent (e.g., 100 loyalty points=1 value credit 150). These value credits 150 may then be converted and/or exchanged to loyalty points in a second merchant's loyalty point system. This conversion rate may be updated at any suitable time. For instance, the conversion rate may be altered due to a merchant devaluing the purchasing power of their loyalty points. In another example, in the case of a merger between two merchants having two loyalty point systems, the conversion rate of each merchant may be altered. If the participant 10 confirms the use of designated loyalty points to complete the transaction, the participant's 10 loyalty account is reduced by the appropriate number of loyalty points in the first merchant's loyalty point system and the second merchant proceeds with the transaction authorization and settlement phase to complete the transaction.

Additional exemplary embodiments relating to the transaction contemplate, (1) integration of a shopping or third party redemption network, (2) integration with external loyalty programs or commercial transaction networks, (3) redemption and conversion of loyalty points for gift products or charitable donations, (4) redemption and conversion of points without a corresponding purchase, e.g., for cash or statement credit, (5) transfer of loyalty points from one party to another, (6) transfer of loyalty points to different transaction instruments or consolidating points onto a single transaction instrument.

Further, the transaction may occur over any computerized network via any suitable user interface system (e.g., internet, phone, wireless, POS terminal, etc.). As used herein, the term “computerized network” includes, but is not limited to any network implemented in the form of a wire-based network (including telephone and cable lines), or as a wireless network (including satellite or cellular networks). It should be noted that the conversion ratio may vary from merchant to merchant according to the merchant's affiliation, if any, with the loyalty program or host clearinghouse account manager 101. Through the loyalty system middleware conversion application 200, the host clearinghouse account manager 101 may adjust conversion ratios to take into account various promotional or incentive marketing programs in order to better serve the needs of its participants 10 or affiliated merchants. By further example, if the host clearinghouse account manager 101 desired to run a promotional program with a valued merchant, the conversion ratio for exchanging loyalty points at the valued merchant (10 loyalty points=1 value credit 150) may be twice the amount for that of an ordinary merchant (20 loyalty points=1 value credit 150).

In various exemplary embodiments, the amount of loyalty point exchanges performed for a specific loyalty program may affect the conversion ratio. In various exemplary embodiments, a fee may be assessed against a loyalty point exchange to a participant 10 to be paid to the host clearinghouse account manager 101. In various exemplary embodiments, a fee may be assessed against a loyalty point exchange to a loyalty point system administrator/merchant to be paid to the host clearinghouse account manager 101. The fee may be a set amount, proportional to the value of loyalty points exchanged for value credits 150, proportional to the currency value of value credits 150 acquired. The fee may be reduced based on a volume of loyalty points exchanges performed or based on a total amount of loyalty points exchanges performed. The fee may allot a proscribed number loyalty points exchanges within a predetermined period. The fee may be reduced or waived based on a referral of a new participant of the system by a prior participant 10. The fee may be paid using a loyalty points equivalent. In various exemplary embodiments, a fee may be assessed against a loyalty point exchange to a participant 10. In various exemplary embodiments, the host clearinghouse account manager 101 may guarantee the transaction by providing a cash, cash equivalent, and/or loyalty point redemption to the merchant provider of items in the event of a default and/or problem with the transaction settlement.

As with traditional purchases using the redemption of loyalty points, the loyalty point exchange details (e.g., temporary or semi permanent account identifier, etc) are provided to the merchant or shopping network system to complete the transaction. The merchant processes this account identifier and associated loyalty point balance for authorization and settlement as is generally done with routine transaction card purchases. In some cases, the host clearinghouse account manager 101 will be associated with the temporary or semi permanent account identifier to facilitate account settlement. For instance, the transaction authorization and settlement phase supports the processes of submitting a transaction record to the host clearinghouse account manager 101. A financial capture system captures the financial information and transaction details and sends this information to an accounts payable system to pay the merchant and to an accounts receivable system to update the participant's 10 account record to reflect the transaction event and apply applicable charges.

During the account reconciliation phase, the accounts receivable system reconciles the charge for the particular transaction with a debit to the participant's 10 loyalty account. In various embodiments, for each charge where the participant 10 selected to pay with loyalty points, there will be a corresponding and offsetting reduction of loyalty points. In various embodiments, where the participant 10 desires to pay only part of the transaction amount with loyalty points, the loyalty credit will only partially offset the merchant charge and the remainder will be paid with the participant's 10 transaction card. In a third embodiment, there may be a credit from a participant's 10 loyalty account without a corresponding transaction charge, such as is the case with a gift certificate embodiment, where the points are converted to a value credit 150 and issued in the form of a gift certificate; or stored on or downloaded to a stored value card or smart card.

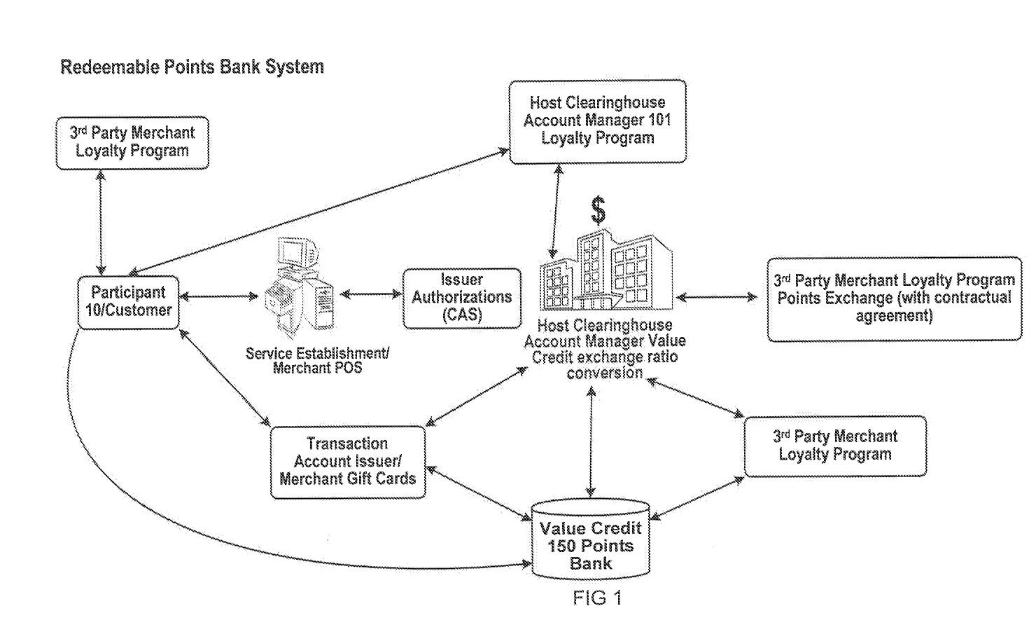

FIG. 1 illustrates exemplary components of the present system 100. To facilitate a transaction using loyalty points, a participant 10 engages a merchant to purchase a product or service using value credit 150 generated by conversion of loyalty points. The host clearinghouse account manager 101 handles the processes to convert the loyalty points from the first merchant's loyalty program to a value credit 150 and then to loyalty points in a second merchant's loyalty program for use in transaction from a second merchant.

As depicted in FIG. 1, an exemplary system may comprise various subsystems and applications, some of which are part of the loyalty program systems, sonic of which are part of the host clearinghouse account manager 101 banking system 100 and database structure, and some of which are used to facilitate interaction between the various systems. The exemplary systems may comprise a user interface system, a merchant point of sale system (POS), a loyalty system middleware 200, a first 3^{rd} party loyalty program, a second 3^{rd} party loyalty program, a host clearinghouse account manager 101 bank, and a card authorization system (CAS). The exemplary components and participants of the present disclosure are described below in more detail.

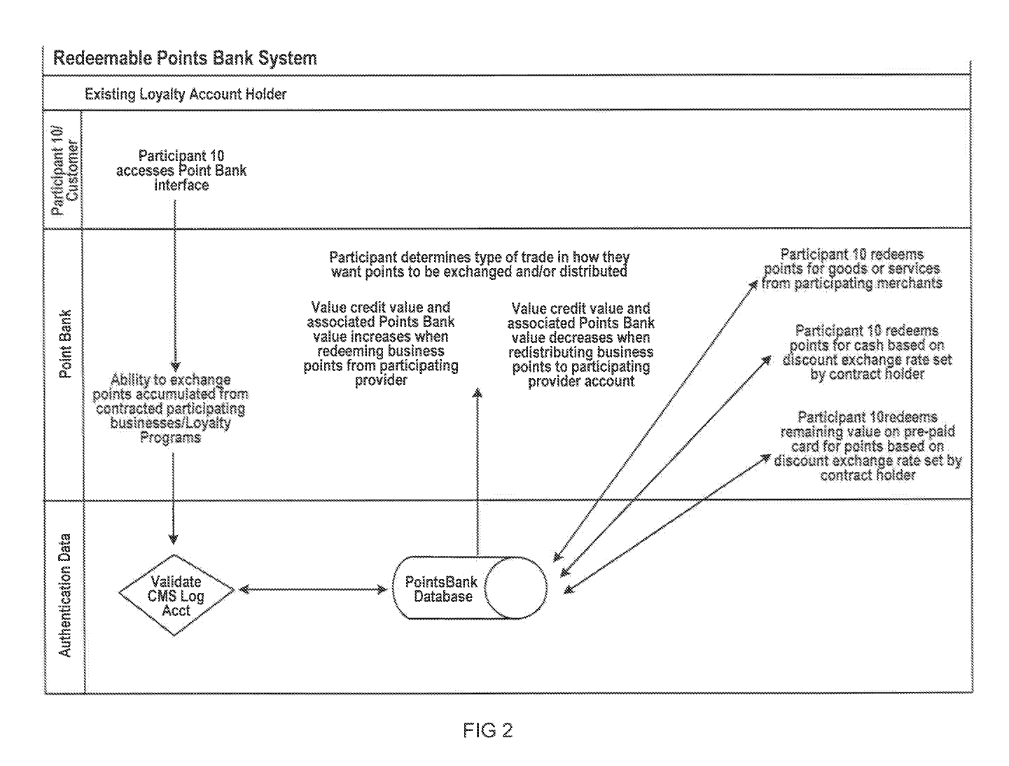

With reference to FIG. 2, the host clearinghouse account manager 101 application 300, such as loyalty system middleware 200, may comprise the functionality to allow loyalty point exchanges for transactions, permit the exchange of loyalty points, use existing transaction facilitation apparati, provide verification of loyalty point balances, establish a universal standard (e.g., value credit 150), allow for card-less (card not present) transactions, facilitate the aggregation of loyalty points for one or more transactions, and provide a single point of contact to display loyalty point balances. In various embodiments, the present system presents a framework. for virtual currency conversion. For instance, it is contemplated that rather than converting loyalty points to a common standard (e.g., value credits 150) and then to loyalty points that merchants may also accept value credits 150 directly. The host clearinghouse account manager 101 application 300 may be a mobile application, or “app.”

The host clearinghouse account manager 101 may contract with each participating merchant individually. This contract may dictate the terms of participation. For instance, this contract may limit the proliferation of loyalty points of each merchant. This contract may establish that the purchasing power of a merchant's loyalty points must be maintained within certain thresholds or the merchant will be subject to penalty,

The host clearinghouse account manager 101 points bank may leverage internal and external databases. If the host clearinghouse account manager 101 is a transaction account issuer, they may access historical spend data of their transaction account holders to present offers, pre-fill forms, store and retrieve loyalty point access codes, target marketing to merchants and participants 10, review and utilize merchant data creditworthiness to use in conversion ratios, and leverage merchant and participant 10 contact information for transaction processing. Additionally, if the host clearinghouse account manager 101 is also a transaction account issuer they may leverage there existing knowledge of facilitating transactions, payment processing systems, fraud prevention and authentication tools.

Merchants participating in the system will enjoy the member perk allowing members/customers greater flexibility and use of accrued loyalty points. Also, by participating in the system, they may also grow their customer lists by gaining access to the customers of other participating merchant loyalty programs. Also, they may garner goodwill with their members/customers as their loyalty points will have more purchasing power.

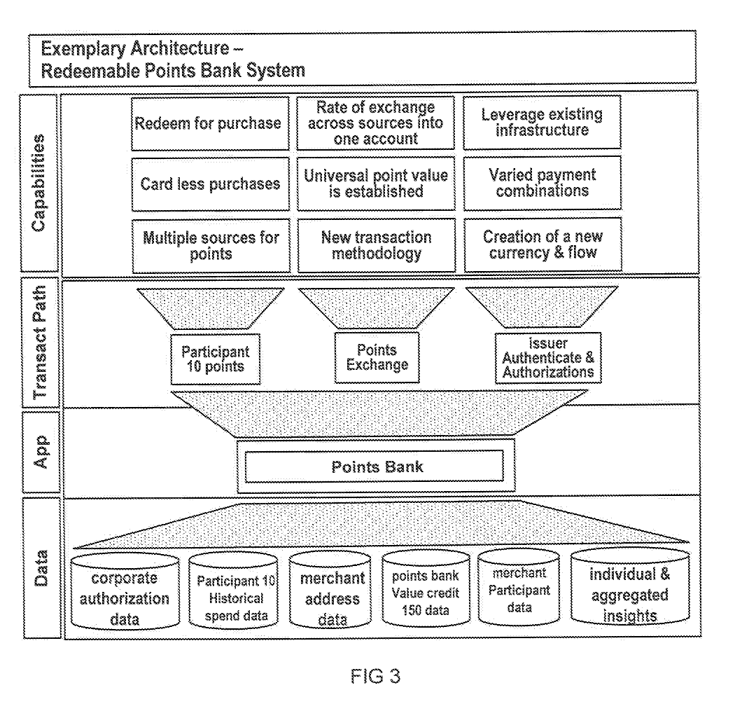

With reference to FIG. 3, a process flow of various embodiments of the system is depicted. A participant 10 may log on the host clearinghouse account manager 101 points bank application 300. The participant's 10 log on information may be verified and/or authenticated, The host clearinghouse account manager 101 points bank application may display on an participant 10 interface the participant's 10 current loyalty point balance and value credit 150 balance. The host clearinghouse account manager 101 points bank application may also display participating merchants who have contracted with the system 100. In various embodiments, specials and offers may be communicated the user/participant 10. Specials may be favorable conversion ratios based on the particular participant's 10 loyalty account balances. Specials may be favorable conversion ratios to value credits 150 based on past transactions of the participant 10 or others using the system. In various embodiments, loyalty point which may be expiring soon may be highlighted to the participant 10 so that they may be converted/exchanged first. In other various embodiments, the system 100/application 300 may indicate via the interface that a recommended loyalty program of points to exchange based on factors. These factors may include, frequency of accruing points in the particular loyalty program, frequency of using points in the particular loyalty program, purchasing power based on special deals, etc, Deal of the day information and limited time offers may be communicated to the participant 10. Offers selected based on the purchase history of the participant 10 using the system and historical transaction account information may be presented to the participant 10.

The participant 10 may determine the type of exchange they would like to perform. For instance, the participant 10 may convert loyalty points to value credits 150, value credits 150 to loyalty points, currency to value credits 150, value credits 150 to currency equivalents, credit to value credits 150, value credits 150 to gift cards, value credits 150 to prepaid accounts, value credits 150 to person/individual to person/individual transaction accounts. The participant's 10 account in the host clearinghouse account manager 101 points hank may be increased or decreased based on this decision or an aggregate of decisions. The host clearinghouse account manager 101 points bank application may facilitate the redemption of good and services. The host clearinghouse account manager 101 points bank application may facilitate the redemption of cash. The host clearinghouse account manager 101 points bank application may facilitate the redemption of a prepaid account.

The participant 10, as used throughout this application, should be understood to mean any individual, business or other entity that desires to use any non-currency tender such as loyalty points to facilitate a transaction. The participant 10 may also be known as and occasionally referred to herein as a “customer,” “cardholder,” “user,” “cardmember,” or the like. In various embodiments, although the participant 10 may be an existing transaction account holder, this is not required. The participant shall mean any person, entity, government organization, business, machine associated with a transaction account, regardless of whether a physical card is associated with the account. For example, the participant may include a transaction account owner, a transaction account user, an account affiliate, a child account user, a subsidiary account user, a beneficiary of an account, a custodian of an account, or any other person or entity affiliated or associated with a transaction account.

Although the participant 10 will generally be enrolled in a loyalty program, such as the American Express Membership Rewards® Program, and will have accumulated loyalty points, this is also not required.

Although the non-currency tender referred to throughout this disclosure is frequently referred to as “loyalty points,” and/or in some instances value credits 150, this disclosure is not so limited. It should be understood the loyalty points includes any type of non-currency tender, such as coupons, frequent flyer miles, incentive awards, frequency awards, and the like. One example of loyalty points contemplated by this disclosure is the membership reward points awarded to participants in the American Express Membership Rewards® program.

Communication among the participant 10, merchant, the host clearinghouse account manager 101 or additional third parties (as may be contemplated by various embodiments) may take place over any computerized network via any suitable user interface system that allow for the exchange of analog or digital information. As such, these systems may include, but are not limited to, telephone interactive voice response or operator-facilitated systems, online or offline computer networked systems using various transfer protocols, wireless devices, personal data assistants, interactive TV, broadband, ultrawide band devices, transponders and the like. For example, the user interface system may comprise web servers and applications configured to facilitate client/server communication over the internet via any wireless or wire-based system. It is also contemplated that certain physical offers, such as coupons, accumulation offers (e.g., buy 9 get one free) may be converted by the system into value credits 150. in various embodiments, these offers may comprise a scalable SKU, barcode, or other code which can be inputted by a user either by taking a photograph or through data entry and submitted to the Points bank for conversion/processing.

The loyalty programs may be any computer system for managing, tracking, and/or reporting loyalty program information. As previously described, the traditional loyalty systems allow participants 10 to accumulate points in a loyalty program account and to then redeem points for merchandise. For example, the American Express Membership Rewards® system allows participants to accumulate points by using their transaction card (American Express® card) to make purchases or by shopping with affiliated merchants. The loyalty program, as contemplated by the present system, may be a stand-alone system or may be affiliated or integrated with other loyalty programs or transaction networks. Moreover, as previously stated, use of this system may function to link two or more disparate transaction networks. The component parts of an exemplary loyalty program generally include computer server and database systems for processing and storing loyalty program account information. As depicted in FIG. 1, the loyalty program system may exist within the host clearinghouse account manager's 101 systems. Alternatively, the loyalty program system may be a separate loyalty program managed by one or more third party.

The loyalty system middleware 200 may be a processing system that is generally configured to facilitate communication between a first loyalty program, a second loyalty program, existing transaction account processing systems, and/or shopping/redemption networks. Specifically, the loyalty system middleware 200 is configured to, inter alia, (1) receive requests to use loyalty points as currency, via a user interface system, (2) verify with the loyalty program that sufficient loyalty points are available, (3) communicate with an authorization system (e.g., CAS), (4) convert loyalty points to value credits 150, and (5) interact with financial capture (e.g., FINCAP) or accounts receivable (AR) systems in order to credit a participant's 10 financial transaction account with the appropriate amount of loyalty currency. The loyalty system middleware 200 may comprise various computer web and application servers, databases, routers, relays and the like in order to suitably process, route, and transmit data among, inter alia, the user interface system, loyalty program, FINCAP, and CAS.

The charge authorization system (CAS), the financial capture system (FINCAP), the accounts payable system (AP) and the accounts receivable system (AR) systems employed by transaction account issuers and card transaction account acquirers to authorize merchant transaction requests and process settlement requests. For example, an exemplary GAS may receive an authorization request from a merchant to determine if the financial transaction account associated with a transaction account code is valid and has sufficient credit. CAS includes systems for comparing the transaction details (e.g., account code, monetary amount of transaction, expiration date, etc) with the participant's 10 financial transaction account information to determine if the financial transaction account is active and if a sufficient credit limit exists to complete a transaction. If these conditions are satisfied, CAS returns to the merchant an approval code reflecting that the merchant is authorized to complete the transaction. The loyalty system middleware 200 or loyalty program may also either reference this same CAS as shown in FIG. 1 to determine if the participant's 10 loyalty account information is valid (and with sufficient loyalty points) or may invoke a separate CAS component and/or CAS equivalent (not shown) to complete the same task.

The merchant computer and the host clearinghouse account manager 101 computer may be interconnected via a second network, referred to as a payment network. The payment network represents existing proprietary networks that presently accommodate transactions for credit cards, debit cards, and other types of financial/banking cards. The payment network is a closed network that is assumed to be secure from eavesdroppers. Examples of the payment network include the American Express®, VisaNet® and the Veriphone® network. While various embodimentss are described in association with a transaction system, the disclosure contemplates any type of networks or transaction systems, including, for example, unsecure networks, public networks, wireless networks, closed networks, open networks, intranets, extranets, and/or the like.

The transaction phase generally includes a participant's 10 successful registration and enrollment to use the present system and method. In general, although not required, a participant 10 will have registered to participate in a loyalty program and will have accumulated at least some loyalty points. However, conducting the transaction before acquiring loyalty points is also contemplated by the system.

The transaction phase may be facilitated using an integrated (i.e., integrated with a shopping network) or stand-alone (i.e., not integrated with a shopping network) system. With additional reference to FIGS. 1-3, these screen shots illustrate various embodimentss utilizing a user interface system suitably configured with an appropriate web server system to facilitate online transactions. It is contemplated that the present system could be used with brick and mortar merchants through the issuance of gift cards redeemed in exchange for value credits 150.

In various embodiments a participant 10 selects an item to purchase (e.g., skis) from a merchant's online web page and selects the payment button. Desiring to use loyalty points, the participant 10 selects the host clearinghouse account manager 101 website and logs-in with appropriate authenticating information such as a username and password. In an alternative embodiment, the participant 10 may access a catalog of products and services offered by merchants by suitably linking to a website hosted on a redemption. network, a shopping network or other system of affiliated merchants that may be situated within or without the host clearinghouse account manager's 101 website domain.

The host clearinghouse account manager 101 website application 300 returns a welcome screen to the participant 10 reflecting participant's 10 loyalty account information, e.g., total points available. The participant 10 is presented with options, for example, to review the loyalty account history, to pay with loyalty points, to return to home page, etc. The participant 10 may select “pay with loyalty points” and/or “exchange loyalty points” to initiate the process to convert loyalty points of a first loyalty point system to the loyalty points of a second loyalty program (via value credit 150 exchange) to facilitate a the transaction. The host clearinghouse account manager 101 website may prompt the participant 10 to key in and/or select from available options appropriate loyalty account and transaction information, e.g., first loyalty program information, second loyalty program information. Options for generating a gift certificate, charitable donations, currency, etc may also be presented. Further, software downloaded to a participant's 10 remote computer may also provide digital wallet features that automatically fills-in loyalty account information. This digital wallet may populate all participating merchant's loyalty program information when needed. For instance, if a participant 10 is an existing member of a participant merchant loyalty program the electronic wallet may store user logon information from that loyalty program for future use. In various embodiments the host clearinghouse account management 101 system 300 may be granted access to the loyalty point information of participant merchants. The host clearinghouse account management 101 system 300 may link participants 10 in the host clearinghouse account management 101 system 300 with their account in the participant merchant loyalty program. For instance, this may occur without the user requiring to provide secure log on information for the particular participating merchant loyalty program to the host clearinghouse account management 101 system 300. In various exemplary embodiments, participant 10 use or association with the host clearinghouse account management 101 system 300/bank with auto enroll the participant 10 in any participant 10 loyalty program (that they are not already a member of). Thus, even if the participant 10 does not use the host clearinghouse account management 101 system 300 for loyalty point exchange they will garner the benefit of loyalty point program enrollment. In various embodiments, the loyalty system middleware 200 may be given access to each participating loyalty programs historical information. For instance, timing of accruing points information may be known to the host clearinghouse account manager 101 loyalty system 300. Loyalty system middleware 200 may be able to determine when offers/or points are expiring or how long it has been since a participant 10 earned points in the particular loyalty system. Using this information, the loyalty system middleware 200 may highlight particular programs to exchange via the user interface.

Upon selecting a continue “button” the loyalty system middleware 200 may be generally configured to interface with a CAS, which can be any form of an account authorization system or network, to validate the transaction request (i.e., to determine if the loyalty points account is valid and if loyalty points or value credits 150 are available in the account). If the account is valid and sufficient loyalty points or value credits 150 are available, the loyalty system middleware 200 interfaces with the loyalty program to calculate the appropriate number of loyalty points necessary to pay for the transaction (e.g., 10,000 points from first loyalty system=250 value credits 150=5,000 points from a second loyalty system) and to determine if sufficient loyalty points are available in the participant's 10 loyalty program account. The participant 10 is presented with a confirmation screen confirming that the participant's 10 loyalty program account will be debited with the appropriate transaction amount (e.g., 10,000 points). In various embodiments the loyalty system middleware 200 integral to system/application 300. Although various embodiments contemplates updating the participant's 10 loyalty account after the transaction has cleared, this updating can be done at any point in the process. Moreover, any portion of the process may utilize real-time or batch processing.

The conversion processor that preferably resides within the loyalty system middleware 200 may be programmed to take into account a plurality of factors to determine the appropriate conversion ratio of loyalty points to value credits 150. Accordingly, loyalty points accumulated by purchases involving a particular vendor may be converted at a higher ratio when the points are redeemed with the same vendor. Similarly, when purchasing with loyalty currency at a host clearinghouse account manager's 101 valued or host clearinghouse account manager 101 affiliated merchant, the account manager may desire to provide the participant 10 with a higher conversion ratio as an incentive. As one skilled in incentive marketing and loyalty systems will appreciate, there may be a multitude of variables that an host clearinghouse account manager 101 and/or affiliated merchant will want to consider in formulating appropriate conversion ratios, including different ratios for holidays, seasons, different times of days, based on remaining inventory of products, based on participant's 10 status, number or loyalty points issued, purchasing power within a loyalty program, strength of brand, credit worthiness, risk of default, based on method of facilitating transaction (e.g., online vs. POS), and/or the like.

In various embodiments, after the conversion ratio and amount of loyalty points are presented to the participant 10, the participant 10 is provided the option to cancel the “pay with loyalty points” and/or “exchange loyalty points” and request or approve the request. If the “pay with loyalty points” is selected, the participant 10 inputs the requisite payment information into the merchant payment fields.

Additional online user interface embodiments for facilitating transactions provide for:

(1) the integration of the merchant website with the host clearinghouse account manager 101 website to provide a seamless environment and “look and feel” between the merchant's payment web page and the account manager's “pay with loyalty points” web page,

(2) the use of an online digital wallet, as described in U.S. Pat. No. 7,343,351 filed on Aug. 31, 2000 (incorporated herein by reference), where participant 10 account information is stored online and is integrated with the account manager features and the online merchant's payment features. In this embodiment an online wallet may be periodically loaded with loyalty points converted to value credit 150. The online wallet may or may not be associated with a participant's 10 financial transaction account.

(3) the implementation of an activator feature that recognizes merchant payment websites during the course of a participant's 10 online session (via an activator software program) and automatically generates a pop-up “pay with loyalty points” button (or window) asking the participant 10 if he desires to pay with loyalty points. This activator program may be downloaded from the account manager's website and may be configured to link the participant 10 to the account manager's website.

(4) using a wireless-enabled mobile device a browser enabled wireless telephone or other portable data device, a participant 10 may desire to convert loyalty points to a currency equivalent when making a purchase at a physical merchant location instead of at a merchant's online website. With this system, using a suitably enabled mobile device, a participant 10 is able to scan SKU numbers of products, send these SKU numbers to the account manager, whereupon the account manager identifies the manufacturer (or merchant) and may employ a suitable conversion ratio depending on the status of the merchant. For example, when shopping at a grocery market, a participant 10 may scan all food items with a mobile device, this information is then transmitted wirelessly to the host clearinghouse account manger 101 application 300, whereupon a conversion processor is invoked and applies a suitable conversion ratio depending on the particular manufacturer involved.

In various embodiments, the transaction authorization and settlement phase is generally the same as traditional financial settlement systems and is well-known in the bank and transaction card industry. As such, the present disclosure contemplates minimal adjustments to existing commercial transaction card processing systems.

In general, after receiving loyalty account information from a participant 10 to complete a purchase, the merchant may submit the information to an authorization network that typically includes a transaction card issuer's charge authorization system such as CAS. The CAS may interact with the loyalty system middleware 200 or directly with the loyalty program to recognize that a loyalty currency credit is associated with the transaction details and to verify that the loyalty account is valid and possesses sufficient credit.

In various embodiments, the loyalty system middleware 200 forwards the appropriate credit to the FINCAP or AR systems to generate a credit to the participant's 10 account. As previously disclosed, various embodiments contemplate the participant 10 to “pay” only part of the transaction amount with loyalty credit, in this instance, the participant 10 statement reflects that the charge is only partially offset and the participant 10 is billed for the remaining amount.

Upon completion of the account reconciliation (or at any point in the transaction event), the loyalty system middleware 200 may interact with the loyalty program to substantially permanently update the participant's 10 loyalty account.

In various embodiments, the loyalty currency credit, the transaction details and the loyalty program accounts may be associated within a transaction log database, a participant 10 financial transaction account database, and/or a participant 10 loyalty account database. This association between the transaction details, any participant 10 transaction accounts and the participant 10 loyalty account facilitate customer service features that are common with transaction account use (e.g., a participant 10 charge-back request and merchandise return, etc.), but have been previously unavailable to those redeeming loyalty points for product. For example, when a participant 10 desires to return a product (that has been purchased using loyalty points) to a merchant, the merchant processes the return the same as with any other transaction card purchase, wherein the merchant posts a credit to the participant's 10 loyalty program account. Alternatively, if desired, the FINCAP, upon accessing the transaction details, may recognize the transaction as involving value credits 150 and/or an exchange of loyalty points and may invoke the loyalty system middleware 200 to perform the appropriate conversion from loyalty points to value credit 150 back to loyalty points, and to adjust the participant's 10 loyalty account accordingly. Similarly, during a dispute handling process where the participant 10 requests a charge-back to the merchant, the account manager's customer service agent is able to retrieve data based on (1) transaction details, (2) transaction account information, or (3) loyalty account details. Accordingly, if a charge-back does occur, the loyalty system middleware 200 may be invoked to adjust the amount of loyalty points in the loyalty account.

Various embodiments contemplate a network of merchants, affiliated with the host clearinghouse account manager 101, that may be searched for a variety of products from within the host clearinghouse account manager's 101 website (or alternatively on a co-branded or third-party website). Upon searching this comprehensive catalog of merchandise, and successfully retrieving a desired list of products to choose from, the server applications are suitably configured to present to the participant 10, a list of the retrieved products, the associated merchant, and/or the cost in (i) value credits 150 (e.g., 250 value credits 150) and (ii) non-currency loyalty points (e.g., 59,958 points). After choosing the pay with points virtual “button” a web page may be presented to the participant 10 requesting account information. As appreciated by one skilled in this art, a variety of fields may be configured depending on the type of transaction system used. As previously noted, to calculate the loyalty point value, the web server is configured to suitably engage the loyalty system middleware 200 which in turn may access the CAS, AR System and/or the Loyalty Program in order to verify that sufficient loyalty points and/or financial transaction account credit are available, and to calculate the number of loyalty points needed to complete the transaction. As the loyalty program (or alternatively the loyalty program. middleware 200) may convert the appropriate amount of a first loyalty programs loyalty points to a value credit 150 and into a second loyalty programs loyalty points. The merchant-specific website may be retrieved and the participant 10 completes the transaction using the merchant-specific (having a second loyalty program) website. The merchant may process the transaction as with any loyalty point transaction.

In various embodiments participants 10 may redeem/spend loyalty points in a variety of ways. First, the loyalty points may be deducted at the time of the transaction processing (e.g., during the initial request or during authorization); or second, the transaction may be reflected on the participant's 10 billing statement along with an associated credit that reflects the payment with loyalty points. It should also be appreciated, that a participant 10 may choose to use loyalty points on a transaction-by-transaction basis, and preferably, is able to combine variations of currency (e.g., credit, debit cards, etc.) and non-currency tender (loyalty points), as desired, to effectuate a transaction.

As briefly described above, another embodiment of the present system uses a stored value card or a smart card where the loyalty points are converted to a value credit 150 and then converted to a currency value and may either be posted to a stored value card account or downloaded to a smart card. In this embodiment, the stored value card functions as a debit card that that draws upon a balance maintained in the stored value card account. The stored value card functions as a debit card and is processed using existing banking systems where, upon use, the stored value card amount is debited by an appropriate amount. To reload or add currency value to the stored value account, a participant 10 adds additional value credits 150 by converting additional loyalty points.

For the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

In various exemplary embodiments, at a high level a participant 10 may be able to exchange their time share loyalty points to purchase items off of a virtual point of sale system, In various exemplary embodiments, a participant 10 may be able to convert a buy 10 get one free stamp card for as sandwich shop toward airline travel. In various embodiments, a participant 10 may exchange a sum of grocery store loyalty points, transaction account loyalty points, coffee house loyalty points plus a credit account value towards a hotel reservation.

The various system components discussed herein may include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. Various databases used herein may include: client data; merchant data; financial institution data; and/or like data useful in the operation of the system. As those skilled in the art will appreciate, user computer may include an operating system (e.g., Windows NT, Windows 95/98/2000, Windows XP, Windows Vista, Windows 7, OS2, UNIX, Linux, Solaris, MacOS, etc.) as well as various conventional support software and drivers typically associated with computers.

In various embodiments, the server may include application servers (e.g. WEB SPHERE, WEB LOGIC, MOSS). In various embodiments, the server may include web servers (e.g. APACHE, IIS, GWS, SUN JAVA SYSTEM WEB SERVER).

A web client includes any device (e.g., personal computer) which communicates via any network, for example such as those discussed herein. Such browser applications comprise Internet browsing software installed within a computing unit or a system to conduct online transactions and/or communications. These computing units or systems may take the form of a computer or set of computers, although other types of computing units or systems may be used, including laptops, notebooks, tablets, hand held computers, personal digital assistants, set-top boxes, workstations, computer-servers, main frame computers, mini-computers, PC servers, pervasive computers, network sets of computers, personal computers, such as iPads, iMACs, and MacBooks, kiosks, terminals, point of sale (PUS) devices and/or terminals, televisions, or any other device capable of receiving data over a network. A web-client may run Microsoft Internet Explorer, Mozilla Firefox, Google Chrome, Apple Safari, or any other of the myriad software packages available for browsing the internet.

Practitioners will appreciate that a web client may or may not be in direct contact with an application server. For example, a web client may access the services of an application server through another server and/or hardware component, which may have a direct or indirect connection to an Internet server. For example, a web client may communicate with an application server via a load balancer. In various embodiments, access is through a network or the Internet through a commercially-available web-browser software package.

As those skilled in the art will appreciate, a web client includes an operating system (e.g., Windows NT, 95/98/2000/CE/Mobile, OS2, UNIX, Linux, Solaris, MacOS, PalmOS, etc.) as well as various conventional support software and drivers typically associated with computers. A web client may include any suitable personal computer, network computer, workstation, personal digital assistant, cellular phone, smart phone, minicomputer, mainframe or the like. A web client can be in a home or business environment with access to a network, in various embodiments, access is through a network or the Internet through a commercially available web-browser software package. A web client may implement security protocols such as Secure Sockets Layer (SSL) and Transport Layer Security (TLS). A web client may implement several application layer protocols including http, https, ftp, and sftp.

In various embodiments, components, modules, and/or engines of system 100 may be implemented as micro -applications or micro-apps, Micro-apps are typically deployed in the context of a mobile operating system, including for example, a Palm mobile operating system, a Windows mobile operating system, an. Android Operating System, Apple iOS, a Blackberry operating system and the like. The micro-app may be configured to leverage the resources of the larger operating system and associated hardware via a set of predetermined rules which govern the operations of various operating systems and hardware resources. For example, where a micro-app desires to communicate with a device or network other than the mobile device or mobile operating system, the micro-app may leverage the communication protocol of the operating system and associated device hardware under the predetermined rules of the mobile operating system. Moreover, where the micro-app desires an input from a user, the micro-app may be configured to request a response from the operating system which monitors various hardware components and then communicates a detected input from the hardware to the micro-app.

As used herein, the term “network” includes any cloud, cloud computing system or electronic communications system or method which incorporates hardware and/or software components. Communication among the parties may be accomplished through any suitable communication channels, such as, for example, a telephone network, an extranet, an intranet, Internet, point of interaction device (point of sale device, personal digital assistant (e.g., iPhone®, Palm Blackberry®), cellular phone, kiosk, etc.), online communications, satellite communications, off-line communications, wireless communications, transponder communications, local area network (LAN), wide area network (WAN), virtual private network (VPN), networked or linked devices, keyboard, mouse and/or any suitable communication or data input modality. Moreover, although the system is frequently described herein as being implemented with TCP/IP communications protocols, the system may also be implemented using IPX, Appletalk, IP-6, NetBIOS, CSI, any tunneling protocol (e.g. IPsec, SSH), or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, DILIP NAIK, INTERNET STANDARDS AND PROTOCOLS (1998); JAVA 2 COMPLETE, various authors, (Sybex 1999); DEBORAH RAY AND ERIC RAY, MASTERING HTML 4.0 (1997); and LOSHIN, TCP/IP CLEARLY EXPLAINED (1997) and DAVID GOURLEY AND BRIAN Taffy, HTTP, THE DEFINITIVE GUIDE (2002), the contents of which are hereby incorporated by reference.

The various system components may be independently, separately or collectively suitably coupled to the network via data links which includes, for example, a connection to an Internet Service Provider (ISP) over the local loop as is typically used in connection with standard modern communication, cable modem, Dish networks, ISDN, Digital Subscriber Line (DSL), or various wireless communication methods, see, e.g., GILBERT HELD, UNDERSTANDING DATA COMMUNICATIONS (1996), which is hereby incorporated by reference. It is noted that the network may be implemented as other types of networks, such as an interactive television (ITV) network. Moreover, the system contemplates the use, sale or distribution of any goods, services or information over any network having similar functionality described herein.

“Cloud” or “Cloud computing” includes a model for enabling convenient, on-demand network access to a shared pool of configurable computing resources (e.g., networks, servers, storage, applications, and services) that can be rapidly provisioned and released with minimal management effort or service provider interaction. Cloud computing may include location-independent computing, whereby shared servers provide resources, software, and data to computers and other devices on demand. For more information regarding cloud computing, see the NIST's (National Institute of Standards and Technology) definition of cloud computing at http://csrc.nist.gov/groups/SNS/cloud-computing/cloud-def-v15.doc (Nast visited Feb. 4, 2011), which is hereby incorporated by reference in its entirety.

As used herein, “transmit” may include sending electronic data from one system component to another over a network connection. Additionally, as used herein, “data” may include encompassing information such as commands, queries, files, data for storage, and the like in digital or any other form.

As used herein, “issue a debit”, “debit” or “debiting” refers to either causing the debiting of a stored value or prepaid card-type financial account, or causing the charging of a credit or charge card-type financial account, as applicable.

Phrases and terms similar to an “item” may include any good, service, information, experience, data, content, access, rental, lease, contribution, account, credit, debit, benefit, right, reward, points, coupons, credits, monetary equivalent, anything of value, something of minimal or no value, monetary value, non-monetary value and/or the like.

The system contemplates uses in association with web services, utility computing, pervasive and individualized computing, security and identity solutions, autonomic computing, cloud computing, commodity computing, mobility and wireless solutions, open source, biometrics, grid computing and/or mesh computing.

One skilled in the art will also appreciate that, for security reasons, any databases, systems devices, servers or other components of the system may consist of any combination thereof at a single location or at multiple locations, wherein each database or system includes any of various suitable security features, such as firewalls, access codes, encryption, decryption, compression, decompression, and/or the like.

Encryption may be performed by way of any of the techniques now available in the art or which may become available—e.g., Twofish, RSA, El Gamal, Schorr signature, DSA, POP, PKI, and symmetric and asymmetric cryptosystems.

The computing unit of the web client may be further equipped with an Internet browser connected to the Internet or an intranet using standard dial-up, cable, DSL or any other Internet protocol known in the art. Transactions originating at a web client may pass through a firewall in order to prevent unauthorized access from users of other networks. Further, additional firewalls may be deployed between the varying components of CMS to further enhance security.

The computers discussed herein may provide a suitable website or other Internet-based graphical user interface which is accessible by users. In various embodiments, the Microsoft Internet Information Server (IIS), Microsoft Transaction Server (MTS), and Microsoft SQL Server, are used in conjunction with the Microsoft operating system, Microsoft NT web server software, a Microsoft SQL Server database system, and a Microsoft Commerce Server. Additionally, components such as Access or Microsoft SQL Server, Oracle, Sybase, Informix MySQL, Interbase, etc., may be used to provide an Active Data Object (ADO) compliant database management system. In various embodiments, the Apache web server is used in conjunction with a Linux operating system, a MySQL database, and the Perl, PHP, and/or Python programming languages.

Any of the communications, inputs, storage, databases or displays discussed herein may be facilitated through a website having web pages. The term “web page” as it is used herein is not meant to limit the type of documents and applications that might be used to interact with the user. For example, a typical website might include, in addition to standard HTML documents, various forms, Java applets, JavaScript, active server pages (ASP), common gateway interface scripts (CGI), extensible markup language (XML), dynamic HTML, cascading style sheets (CSS), AJAX (Asynchronous Javascript And XML), helper applications, plug-ins, and the like. A server may include, a web service that receives a request from a web server, the request including a URL (http://yahoo.com/stockquotes/ge) and an IP address (123.56.789.234). The web server retrieves the appropriate web pages and sends the data or applications for the web pages to the IP address. Web services are applications that are capable of interacting with other applications over a communications means, such as the internet. Web services are typically based on standards or protocols such as XML, SOAP, AJAX, WSDL, and UDDI. Web services methods are well known in the art, and are covered in many standard texts. See, e.g., ALEX NGHIEM, IT WEB SERVICES: A ROADMAP FOR THE ENTERPRISE (2003), hereby incorporated by reference.

Middleware 200 may include any hardware and/or software suitably configured to facilitate communications and/or process transactions between disparate computing systems, Middleware components are commercially available and known in the art. Middleware 200 may be implemented through commercially available hardware and/or software, through custom hardware and/or software components, or through a. combination thereof. Middleware 200 may reside in a variety of configurations and may exist as a standalone system or may be a software component residing on the Internet server. Middleware 200 may be configured to process transactions between the various components of an application server and any number of internal or external systems for any of the purposes disclosed herein, WebSphere MQTM (formerly MQSeries) by IBM, Inc. (Armonk, N.Y.) is an example of a commercially available middleware product. An Enterprise Service Bus (“ESB”) application is another example of middleware. In various embodiments a mobile app is another example of middleware,

Practitioners will also appreciate that there are a number of methods for displaying data within a browser-based document. Data may be represented as standard text or within a fixed list, scrollable list, drop-down list, editable text field, fixed text field, pop-up window, and the like. Likewise, there are a number of methods available for modifying data in a web page such as, for example, free text entry using a keyboard, selection of menu items, check boxes, option boxes, and the like.

The system and method may be described herein in terms of functional block components, screen shots, optional selections and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, Java, JavaScript, VBScript, Macromedia Cold Fusion, COBOL, Microsoft Active Server Pages, assembly, PERL, PHP, awk, Python, Visual Basic, SQL Stored Procedures, PL/SQL, any UNIX shell script, and extensible markup language (XML)) with the various algorithms being implemented with any combination of data structures, objects, processes, routines or other programming elements. Further, it should be noted that the system may employ any number of conventional techniques for data transmission, signaling, data processing, network control, and the like. Still further, the system could be used to detect or prevent security issues with a client-side scripting language, such as JavaScript, VBScript or the like. For a basic introduction of cryptography and network security, see any of the following references: (1) “Applied Cryptography: Protocols, Algorithms, And Source Code In C,” by Bruce Schreier, published by John Wiley & Sons (second edition, 1995); (2) “Java Cryptography” by Jonathan Knudson, published by O'Reilly & Associates (1998); (3) “Cryptography & Network Security: Principles & Practice” by William Stallings, published by Prentice Hall; all of which are hereby incorporated by reference.

As used herein, the term “participant,” “end user”, “consumer”, “customer”, “cardmember”, “business” or “merchant” may be used interchangeably with each other, and each shall mean any person, entity, government organization, business, machine, hardware, and/or software. A bank may be part of the system, but the hank may represent other types of card issuing institutions, such as credit card companies, card sponsoring companies, or third party issuers under contract with financial institutions. It is further noted that other participants may be involved in some phases of the transaction, such as an intermediary settlement institution, but these participants are not shown.

Each participant is equipped with a computing device in order to interact with the system and facilitate online commerce transactions. The customer has a computing unit in the form of a personal computer, although other types of computing units may be used including laptops, notebooks, hand held computers, set-top boxes, cellular telephones, touch-tone telephones and the like. The merchant has a computing unit implemented in the form of a computer-server, although other implementations are contemplated by the system. The bank has a computing center shown as a main frame computer. However, the bank computing center may be implemented in other forms, such as a mini-computer, a PC server, a network of computers located in the same of different geographic locations, or the like. Moreover, the system contemplates the use, sale or distribution of any goods, services or information over any network having similar functionality described herein.

The merchant computer and the bank computer may be interconnected via a second network, referred to as a payment network. The payment network which may be part of certain transactions represents existing proprietary networks that presently accommodate transactions for credit cards, debit cards, and other types of financial/banking cards. The payment network is a closed network that is assumed to be secure from eavesdroppers. Exemplary transaction networks may include the American Express®, VisaNet® and the Veriphone® networks.

The electronic commerce system may be implemented at the customer and issuing bank. In an exemplary implementation, the electronic commerce system is implemented as computer software modules loaded onto the customer computer and the banking computing center. The merchant computer does not require any additional software to participate in the online commerce transactions supported by the online commerce system.

As will be appreciated by one of ordinary skill in the art, the system may be embodied as a customization of an existing system, an add-on product, a processing apparatus executing upgraded software, a stand alone system, a distributed system, a method, a data processing system, a device for data. processing, and/or a computer program product. Accordingly, any portion of the system or a module may take the form of a processing apparatus executing code, era internee based embodiment, an entirely hardware embodiment, or an embodiment combining aspects of the internet, software and hardware. Furthermore, the system may take the form of a computer program product on a computer-readable storage medium having computer-readable program code means embodied in the storage medium. Any suitable computer-readable, storage medium may be utilized, including hard disks, CD-ROM, optical storage devices, magnetic storage devices, and/or the like.

The system and method is described herein with reference to block diagrams and flowchart illustrations of methods, apparatus (e.g., systems), and computer program products according to various embodiments. It will be understood that each functional block of the block diagrams and the flowchart illustrations, and combinations of functional blocks in the block diagrams and flowchart illustrations, respectively, can be implemented by computer program. instructions.

Referring now to FIGS. 2-3 the process flows depicted are merely embodiments and are not intended to limit the scope of the disclosure. For example, the steps recited in any of the method or process descriptions may be executed in any order and are not limited to the order presented. It will be appreciated that the following description makes appropriate references not only to the steps and user interface elements depicted in FIGS. 2-3, but also to the various system components as described above with reference to FIG. 1.

These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. it will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user windows, webpages, websites, web forms, prompts, etc. Practitioners will appreciate that the illustrated steps described herein may comprise in any number of configurations including the use of windows, webpages, web forms, popup windows, prompts and the like. It should be further appreciated that the multiple steps as illustrated and described may be combined into single webpages and/or windows but have been expanded for the sake of simplicity. In other cases, steps illustrated and described as single process steps may be separated into multiple webpages and/or windows but have been combined for simplicity.

The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” and “non-transitory computer-readable storage medium” should be construed to exclude only those types of transitory computer-readable media which were found in In Re Nuijten to fall outside the scope of patentable subject matter under 35 U.S.C. §101.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to ‘at least one of A, B, and C’ or ‘at least one of A, B, or C’ is used in the claims or specification, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Although the disclosure includes a method, it is contemplated that it may be embodied as computer program instructions on a tangible computer-readable carrier, such as a magnetic or optical memory or a magnetic or optical disk. All structural, chemical, and functional equivalents to the elements of the above-described exemplary embodiments that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

Phrases and terms similar to an “entity” may include any individual, consumer, customer, group, business, organization, government entity, transaction account issuer or processor (e.g., credit, charge, etc), merchant, consortium of merchants, account holder, charitable organization, software, hardware, and/or any other type of entity. The terms “user,” “consumer,” “purchaser,” and/or the plural form of these terms are used interchangeably throughout herein to refer to those persons or entities that are alleged to be authorized to use a transaction account.

Phrases and terms similar to “account”, “account number”, “account code” or “consumer account” as used herein, may include any device, code (e.g., one or more of an authorization/access code, personal identification number (“PIN”), Internet code, other identification code, and/or the like), number, letter, symbol, digital certificate, smart chip, digital signal, analog signal, biometric or other identifier/indicia suitably configured to allow the consumer to access, interact with or communicate with the system. The account number may optionally be located on or associated with a rewards account, charge account, credit account, debit account, prepaid account, telephone card, embossed card, smart card, magnetic stripe card, bar code card, transponder, radio frequency card or an associated account.

The terms account holder, participant 10, cardmember or CM (and the plural form of these terms) shall mean any person, entity, government organization, business, machine associated with a transaction account, regardless of whether a physical card is associated with the account. For example, the cardmember and/or CM may include a transaction account owner, an transaction account user, an account affiliate, a child account user, a subsidiary account user, a beneficiary of an account, a custodian of an account, or any other person or entity affiliated or associated with a transaction account.

Phrases and terms similar to “transaction account” may include any account that may be used to facilitate a financial transaction. Phrases and terms similar to “financial institution” or “transaction account issuer” may include any entity that offers transaction account services. Although often referred to as a “financial institution,” the financial institution may represent any type of bank, lender or other type of account issuing institution, such as credit card companies, card sponsoring companies, or third party issuers under contract with financial institutions. It is further noted that other participants may be involved in some phases of the transaction, such as an intermediary settlement institution.

Phrases and terms similar to “business” or “merchant” may be used interchangeably with each other and shall mean any person, entity, distributor system, software and/or hardware that is a provider, broker and/or any other entity in the distribution chain of items. For example, a. merchant may be a grocery store, a retail store, a travel agency, a service provider, an on-line merchant or the like.

The terms “payment vehicle,” “financial transaction instrument,” “transaction instrument” and/or the plural form of these terms may be used interchangeably throughout to refer to a financial instrument.

Phrases and terms similar to “merchant,” “supplier” or “seller” may include any entity that receives payment or other consideration. For example, a supplier may request payment for goods sold to a buyer who holds an account with a transaction account issuer.

Phrases and terms similar to a “buyer” may include any entity that receives goods or services in exchange for consideration (e.g. financial payment). For example, a buyer may purchase, lease, rent, barter or otherwise obtain goods from a supplier and pay the supplier using a transaction account.

Phrases and terms similar to “internal data” may include any data a credit issuer possesses or acquires pertaining to a particular consumer. Internal data may be gathered before, during, or after a relationship between the credit issuer and the transaction account holder (e.g., the consumer or buyer). Such data may include consumer demographic data. Consumer demographic data includes any data pertaining to a consumer. Consumer demographic data may include consumer name, address, telephone number, email address, employer and social security number. Consumer transactional data is any data pertaining to the particular transactions in which a consumer engages during any given time period. Consumer transactional data may include, for example, transaction amount, transaction time, transaction vendor/merchant, and transaction vendor/merchant location. Transaction vendor/merchant location may contain a high degree of specificity to a vendor/merchant. For example, transaction vendor/merchant location may include a particular gasoline filing station in a particular postal code located at a particular cross section or address. Also, for example, transaction vendor/merchant location may include a particular web address, such as a Uniform Resource Locator (“URL”), an email address and/or an Internet Protocol (“IP”) address for a vendor/merchant. Transaction vendor/merchant, and transaction vendor/merchant location may be associated with a particular consumer and further associated with sets of consumers. Consumer payment data includes any data pertaining to a consumer's history of paying debt obligations. Consumer payment data may include consumer payment dates, payment amounts, balance amount, and credit limit. Internal data may further comprise records of consumer service calls, complaints, requests for credit line increases, questions, and comments. A record of a consumer service call includes, for example, date of call, reason for call, and any transcript or summary of the actual call.

Phrases similar to a “payment processor” may include a company (e.g., a third party) appointed (e.g., by a merchant) to handle transactions for merchant banks. Payment processors may be broken down into two types: front-end and back-end. Front-end payment processors have connections to various transaction accounts and supply authorization and settlement services to the merchant banks' merchants. Back-end payment processors accept settlements from front-end payment processors and, via The Federal Reserve Bank, move money from an issuing bank to the merchant bank. In an operation that will usually take a few seconds, the payment processor will both check the details received by forwarding the details to the respective account's issuing bank or card association for verification, and may carry out a series of anti-fraud measures against the transaction. Additional parameters, including the account's country of issue and its previous payment history, may be used to gauge the probability of the transaction being approved. In response to the payment processor receiving confirmation that the transaction account details have been verified, the information may be relayed back to the merchant, who will then complete the payment transaction. In response to the verification being denied, the payment processor relays the information to the merchant, who may then decline the transaction. Phrases similar to a “payment gateway” or “gateway” may include an application service provider service that authorizes payments for e-businesses, online retailers, and/or traditional brick and mortar merchants. The gateway may be the equivalent of a. physical point of sale terminal located in most retail outlets. A payment gateway may protect transaction account details by encrypting sensitive information, such as transaction account numbers, to ensure that information passes securely between the customer and the merchant and also between merchant and payment processor.

1. A system comprising:
a processor configured to convert loyalty points to a standard value credit,
a tangible, non-transitory storage memory configured to communicate with the processor,
the tangible, non-transitory storage memory having instructions stored thereon that, in response to execution by the processor, cause the processor to perform operations comprising:
granting, by the processor, access to a participant to a user interface in response to a verified log on by the participant;
converting, by the processor, a first value of loyalty points in a first loyalty point system to a first value of value credits according to a first conversion ratio, wherein the first conversion ratio is particular to a first merchant;
storing, by the processor, the first value of value credits;
converting, by the processor, a second value of value credits to a second value of loyalty points in a second loyalty point system according to a second conversion ratio, wherein the second conversion ratio is particular to a second merchant; and
transmitting, by the processor, instructions to the second loyalty point system to adjust the loyalty point balance to the second value of loyalty points.

2. The system of claim 1, further comprising storing, by the processor, data representing a value of value credits associated with an account of the participant.

3. The system of claim 1, further comprising transmitting, by the processor, instructions to a merchant affiliated with the second loyalty point system to perform a redemption of loyalty points.

4. The system of claim 1, further comprising converting, by the processor, a third value of value credits to a third value of currency equivalent to be stored to a transaction account.

5. The system of claim 4, wherein the transaction account is a pre-paid account.

6. The system of claim 1, enrolling a participant in the system in at least one participating merchant loyalty system automatically without participant enrollment personal information being provided by the participant.

7. The system of claim 1, wherein the system provider provides a guarantee associated with loyalty point exchange transactions.

8. The system of claim 1, wherein loyalty point exchange offers are presented to the participant based on historical transaction account spend trends.

9. The system of claim 1, wherein a fee is assessed by the system administrator for each loyalty point exchange.

10. The system of claim 1, further comprising verifying a loyalty point balance of a participant in a third party loyalty system.

11. The system of claim 1, further comprising establishing with a merchant loyalty point system provider a conversion ratio applicable to loyalty point exchanges by contract.

12. The system of claim 1, further comprising offering suggestions of loyalty points exchanges based on at least one frequency of loyalty point use and frequency of loyalty point accrual.

13. The system of claim 1, further comprising offering suggestions of loyalty points exchanges based purchasing power of loyalty points.

14. The system of claim 1, further comprising adjusting the conversion ratio of loyalty point exchange in response to the volume of historical loyalty point exchanges of the participant.

15. The system of claim. 1, further comprising presenting an offer of an item to purchase with loyalty points based on a particular participant's loyalty point aggregated purchasing power balance.

16. The system of claim 1, further comprising populating loyalty point system information via a digital wallet.

17. The system of claim 1, wherein the system is administered by a transaction account issuer.

18. The system of claim 1, further comprising completing a transaction with both loyalty points and a transaction account.

19. A computer-implemented method comprising:
granting, by a computer-based system for loyalty point exchange, access to a participant to a user interface in response to a verified log on by the participant;
converting, by the computer-based system, a first value of loyalty points in a first loyalty point system to a first value of value credits according to a first conversion ratio, wherein the first conversion ratio is particular to a first merchant;
storing, by the computer-based system, the first value of value credits;
converting, by the computer-based system, a second value of value credits to a second value of loyalty points in a second loyalty point system according to a second conversion ratio, wherein the second conversion ratio is particular to a second merchant; and
transmitting, by the computer-based system, instructions to the second loyalty point system to adjust the loyalty point balance to the second value of loyalty points.

20. An article of manufacture including a non-transitory, tangible computer readable storage medium having instructions stored thereon that, in response to execution by a computer-based system for loyalty point exchange, cause the computer-based system to perform operations comprising:
granting, by the computer-based system, access to a participant to a user interface in
response to a verified log on by the participant;
converting, by the computer-based system, a first value of loyalty points in a first loyalty point system to a first value of value credits according to a first conversion ratio, wherein the first conversion ratio is particular to a first merchant;
storing, by the computer-based. system, the first value of value credits;
converting, by the computer-based system, a second value of value credits to a second value of loyalty points in a second loyalty point system according to a second conversion ratio, wherein the second conversion ratio is particular to a second merchant; and
transmitting, by the computer-based system, instructions to the second loyalty point system to adjust the loyalty point balance to the second value of loyalty points.
